(19) United States
(12) Patent Application Publication
(10) Pub. No.: US 2026/0268289 A1
(43) Pub. Date: Sep. 10, 2026

(54) INFORMATION PROVISION DEVICE, INFORMATION PROVISION METHOD, AND RECORDING MEDIUM

(71) Applicant: NEC Corporation, Tokyo (JP)

(72) Inventor: Hironobu HORI, Tokyo (JP)

(73) Assignee: NEC Corporation, Tokyo (JP)

(21) Appl. No.: 19/454,569

(22) Filed: Jan. 21, 2026

(30) Foreign Application Priority Data
Mar. 10, 2025 (JP) 2025-037288

(51) Int. Cl. G06Q 10/40

(52) U.S. Cl. CPC G06Q 10/40

(57) ABSTRACT

An information provision device includes one or more memories storing instructions; and one or more processors configured to execute the instructions to: acquire behavior information on a user including information indicating behavior of the user on the Internet and a terminal device, generate a profile of the user, based on the behavior information, generate one or multiple avatars of the user, based on the profile, create an account of a social networking service (SNS) on which the avatars make a post, collect related information related to an interest or the behavior of the user, based on the profile, generate post content to the SNS, based on the related information, and provide information to the user by posting the post content, using the account.

This application is based upon and claims the benefit of priority from Japanese Patent Application No. 2025-037288, filed on Mar. 10, 2025, the disclosure of which is incorporated herein in its entirety by reference.

### TECHNICAL FIELD

The present disclosure relates to an information provision device, an information provision method, and a recording medium.

### BACKGROUND ART

JP 2003-58569 A describes an information provision system that acquires a keyword or the like used by a user for Internet search, as a user profile, and provides website information to be provided to the user that has been determined based on the user profile to a mobile terminal of the user.

### SUMMARY

An example of an object of the present disclosure is to provide a technology for providing information that allows users to more comfortably collect information.

An information provision device according to an aspect of the present disclosure includes a user information acquisition means for acquiring behavior information on a user including information indicating behavior of the user on the Internet and a terminal device, a profile generation means for generating a profile of the user, based on the behavior information, an avatar generation means for generating one or multiple avatars of the user, based on the profile, an account creation means for creating an account of a social networking service (SNS) on which the avatars make a post, a collection means for collecting related information related to an interest or the behavior of the user, based on the profile, a post generation means for generating post content to the SNS, based on the related information, and an information provision means for providing information to the user by posting the post content, using the account.

An information provision method according to an aspect of the present disclosure includes acquiring behavior information on a user including information indicating behavior of the user on the Internet and a terminal device, generating a profile of the user, based on the behavior information, generating one or multiple avatars of the user, based on the profile, creating an account of an SNS on which the avatars make a post, collecting related information related to an interest or the behavior of the user, based on the profile, generating post content to the SNS, based on the related information, and providing information to the user by posting the post content, using the account.

A program according to an aspect of the present disclosure causes a computer to execute a process including acquiring behavior information on a user including information indicating behavior of the user on the Internet and a terminal device, generating a profile of the user, based on the behavior information, generating one or multiple avatars of the user, based on the profile, creating an account of an SNS on which the avatars make a post, collecting related information related to an interest or the behavior of the user, based on the profile, generating post content to the SNS, based on the related information, and providing information to the user by posting the post content, using the account.

The program may be stored in a non-transitory computer-readable recording medium.

### BRIEF DESCRIPTION OF THE DRAWINGS

FIG. 1 is a diagram illustrating a configuration example and a concept of an information provision system including an information provision device;

FIG. 2 is a block diagram illustrating an example of a functional configuration of the information provision device;

FIG. 3 is a flowchart illustrating an example of an action of the information provision device;

FIG. 4 is a flowchart illustrating another example of the action of the information provision device; and

FIG. 5 is a diagram illustrating a hardware configuration for achieving the information provision device according to the present disclosure on a computer and peripheral devices of the computer.

### EXAMPLE EMBODIMENT

Hereinafter, example embodiments of the present disclosure will be described in detail with reference to the drawings.

### Example Embodiment

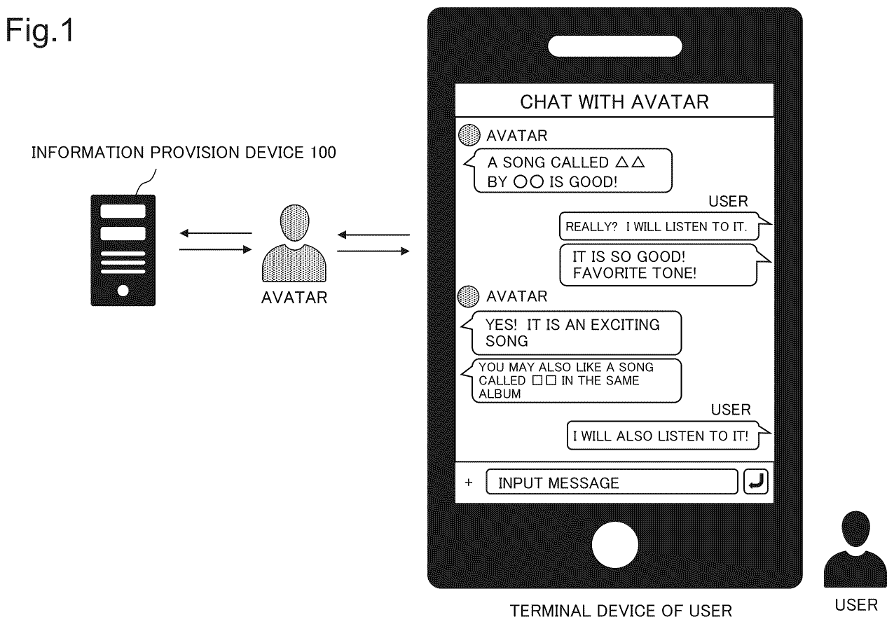

FIG. 1 is a diagram illustrating an exemplary configuration and a concept of an information provision system including an information provision device 100 according to the present disclosure.

In FIG. 1, the information provision system includes the information provision device 100 and a terminal device of a user.

The information provision device 100 is a device that provides information to the user, using an avatar. In other words, in the present disclosure, the user accepts provided information in a form such as having an interaction with the avatar in a social networking service (SNS). The avatar and the SNS will be described later.

The information provision device 100 is achieved by a server, a cloud computing system, or the like, for example, but a hardware configuration for achieving the information provision device 100 is not limited to these examples.

The information provision device 100 is connected to the terminal device used by the user who is a target to be provided with information, in such a manner that communication is enabled.

The terminal device is a terminal device used by the user who is a target to be provided with information by the information provision device 100. The terminal device is achieved by a smartphone, a tablet, or the like, for example. The terminal device may also be achieved by wearable equipment such as a smart watch or smart glasses and is not particularly limited.

The avatar is a character or an icon that performs an action like a virtual self of the user in a virtual space such as the Internet.

In the present disclosure, the avatar is generated in the information provision device 100 and performs actions such as information collection, information provision, and interaction with the user, as one function of the information provision device 100. In a case where the avatar interacts with the user, the avatar serves as a virtual interaction partner.

In FIG. 1, the avatar is provided outside the information provision device 100, but this is a diagram for conceptual description indicating that the user feels as if accepting provided information from the avatar. In practice, information regarding the avatar may be stored inside the information provision device 100, the terminal device, or a storage unit connected to the information provision device 100 and the terminal device in such a manner that communication is enabled.

The SNS is a service or a website that allows a user such as an individual or an organization to transmit information. Information transmission may sometimes be referred to as posting. There are various kinds of information to be transmitted or posted, such as text, audio, and images such as still images and moving images. The SNS also enables an interaction between users by sending and receiving information or sending a reaction. The SNS is also referred to as social media.

The SNS has functions such as a timeline function in which various posts are displayed in rows and a chat function specialized for message exchange.

In many SNSs, an account is assigned to each user in order to allow each user to make a post. The user creates an account by registering predetermined information on the SNS and, for example, browses or posts on the SNS, using the created account.

In the present disclosure, the SNS may be a service provided by the information provision device 100 or a service provided by a device different from the information provision device 100. In the present disclosure, a business operator that provides the SNS service and a business operator that provides an information provision service by the information provision device 100 may be the same or different business operators.

The information provision device 100 may be included in the terminal device, and the configuration of the information provision system is not limited to the example in FIG. 1.

Next, a configuration of the information provision device 100 according to an example embodiment will be described.

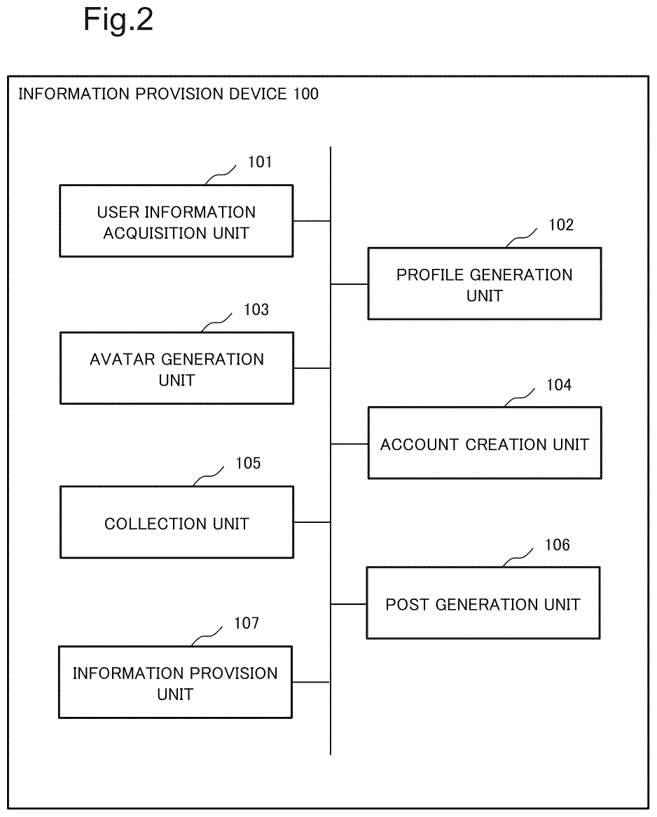

FIG. 2 is a block diagram illustrating a configuration of the information provision device 100. Referring to FIG. 2, the information provision device 100 includes a user information acquisition unit 101, a profile generation unit 102, an avatar generation unit 103, an account creation unit 104, a collection unit 105, a post generation unit 106, and an information provision unit 107.

Next, a configuration of the information provision device 100 according to a first example embodiment will be described in detail.

The user information acquisition unit 101 is an example of a user information acquisition means for acquiring behavior information on the user including information indicating behavior of the user on the Internet and the terminal device.

The behavior information is information indicating a history of the behavior of the user. Here, the behavior of the user may include behavior in a real physical space, behavior on the Internet, and behavior on the terminal device. The behavior information may also include information indicating a schedule of the behavior of the user.

Examples of the behavior in the real physical space include movement, a visit to a facility, participation in an event, a meeting with a person, and purchase of a product or a service. That is, for example, the behavior information in the real physical space is position information on the terminal device, information indicating a facility that has been visited and is indicated in a schedule, a mail, a post to an SNS, or the like, information indicating an event in which the user has participated, information indicating a person whom the user has met, a purchase history associated with member information, for example, for a store, and the like.

Examples of the behavior on the Internet include browsing a website and posting to an SNS or the like. That is, the behavior information on the Internet is a browsing history of websites, a posting history to, for example, an SNS, and the like.

Examples of the behavior on the terminal device include operating an application or the like in the terminal device, and saving various sorts of data such as text, an image, or audio. That is, the behavior information on the terminal device is an operation log on the terminal device and data saved in the terminal device.

Examples of the user's behavior and behavior information are not limited to these examples, and the behavior information only needs to be information indicating the behavior of the user. The method by which the user information acquisition unit 101 collects the behavior information is not particularly limited.

The user information acquisition unit 101 may temporarily acquire the behavior information or may acquire the behavior information over time, for example, at predetermined time intervals. For example, the user information acquisition unit 101 may acquire the behavior information in a case where a request to generate an avatar is accepted from the user.

The profile generation unit 102 is an example of a profile generation means for generating a profile of the user, based on the behavior information.

The profile is information related to an interest and behavior of the user. For example, the profile is information indicating an interest or behavior of the user or information that allows estimation of the basis of the behavior of the user.

The profile is, for example, a model that hierarchically represents interests of the user. In this case, for example, the profile generation unit 102 specifies categories of the interests from the behavior information, using a technique such as hierarchical clustering, and generates a profile by weighting each category.

The weighting in this case may be weighting according to the extent of interest of the user or the frequency of behavior, or may be weighting designed to put a large weight on a new interest or behavior. These weighting methods may be combined.

For example, the profile is a typical behavior pattern of the user represented by a vector. In this case, for example, the profile generation unit 102 generates a profile by vectorizing the behavior for each time slot and clustering the vectorized behavior to extract a typical behavior pattern.

For example, the profile may also be the whole behavior information on the user, statistical data of the behavior information on the user, or the like.

The data structure and the generation method for the profile are not limited to these examples.

The avatar generation unit 103 is an example of an avatar generation means for generating one or multiple avatars of the user, based on the profile.

Here, as described earlier, the avatar is a character or an icon that performs an action like a virtual self of the user in a virtual space such as the Internet. The action is an action such as an action of collecting information, an action of providing information, and an action of making determination for performing these actions. That is, the avatar is an information processing model for performing at least an action related to information provision. The avatar may include data for displaying an appearance according to the SNS on which information is provided.

The avatar generation unit 103 generates, for example, a model that makes an action based on the profile.

The model may be, for example, a model that makes an action by determining an action to be carried out, using a rule generated based on the profile. For example, the model may be a machine learning model that has learned the relationship between the profile and the behavior. Furthermore, the model may be a large language model (LLM) that makes an action in a case where the profile and an instruction to cause the LLM to determine an action are input. The model is not limited to these examples and only needs to be any model that can perform an action based on the profile of the user, using a known technique.

A trigger of an action may be set in the model. For example, the trigger of an action is that a predetermined time has come, that the user has had specified behavior, based on the behavior information on the user, or the like. Here, for example, the specified behavior may be an operation by the user on the SNS on which the avatar provides information, movement of the user by a predetermined distance or more, search on the terminal device of the user, or the like. That is, the specified behavior is behavior of the user that may be likely to expect information to be provided, behavior of the user that is considered to have a margin for accepting provided information, or the like.

The model accepts, as an input, information indicating specified behavior or information indicating an interest or behavior of the user specified from the specified behavior and outputs an action based on the profile. For example, the model also selects one of an interest or behavior of the user according to the trigger and outputs an action (information for performing an action) based on the profile, with information indicating the selected interest or behavior as an input.

Outputting an action based on the profile by the model may be outputting information for performing an action. For example, outputting an action based on the profile may be performing an action based on the profile.

An action based on the profile is, for example, an action that is considered to be likely to be executed by the user, based on the profile. Examples of the action based on the profile include an action of collecting information related to an interest or behavior of the user, an action of selecting behavior to be executed based on information related to an interest or behavior of the user, an action of sharing behavior to be executed with another person, or an action of executing the selected behavior. Here, an action of executing the selected behavior by the model is an action assumed in a case where the selected behavior is assumed to be executed and is, for example, an action of having impressions, an action of sharing impressions, and the like in a case where the selected behavior is assumed to be executed.

The method for selecting one of an interest or behavior of the user is not particularly limited, and one of an interest or behavior may be selected based on the level of interest of the user or the temporal closeness of the behavior of the user or may be selected randomly.

A known technique may be used for a method by which the avatar generation unit 103 generates the model as described above.

For example, the avatar may be an avatar that is similar to but not the same as the user. That is, the avatar may be generated in such a way as to perform an action similar to the behavior of the user from a certain viewpoint but is different from the behavior of the user from another viewpoint.

For example, the avatar is generated in such a way as to perform behavior in a category same as the category of interest of the user, which is an action that has not been performed by the user in the same category but is related to a category or an element in a finer layer of the interest. For example, the avatar is generated in such a way as to perform an action related to a point that is within a predetermined range from the point where the user is staying but is different from the point where the user is staying.

The avatar generation unit 103 may generate a plurality of avatars. In this case, for example, the avatar generation unit 103 may generate models, based on each of a plurality of profiles whose weights are changed. This may allow the plurality of avatars to provide more information.

The avatar generation unit 103 may also generate a plurality of models based on the same profile. In this case, by making the triggers of actions set in the models and the information to be input into the models different for each avatar, it may be possible to provide a lot of information by causing each avatar to make different actions.

The avatar generation unit 103 may further generate appearance data for displaying an appearance according to the SNS on which information is provided. The appearance data according to the SNS is data that can display a shape of a character or an icon, a format for saving data, and the like.

The avatar generation unit 103 may generate the appearance data in accordance with an operation input from the user, or may generate the appearance data, based on an image obtained by imaging the user. The method for generating the appearance data of the avatar is not particularly limited, and a known technique can be used.

The account creation unit 104 is an example of an account creation means for creating an account of the SNS on which the avatar makes a post. The account created by the account creation unit 104 is an account used by the avatar to provide information.

The account creation unit 104 creates an account in line with a procedure for creating an account of the SNS. The method for creating an account is not particularly limited.

For example, the account creation unit 104 may create an account, using information such as a mail address and a telephone number of the user. The account creation unit 104 may also create an identifier (ID) used to log in to the account. For example, the account creation unit 104 may create the ID by adding a predetermined character string to the ID of the account used by the user or by randomly generating a character string. Furthermore, the account creation unit 104 may create a password used to log in to the account. For example, the account creation unit 104 may create a password by randomly generating a character string. When creating at least one of the ID and the password, the account creation unit 104 may notify the user of the created ID or password as login information.

The account may be created by the user. In this case, the account creation unit 104 logs in to the account created by the user, based on the login information acquired from the user. Here, the method for acquiring the login information from the user may be accepting an input of the login information from the user, or may be acquiring information input by the user in a case where creating the account on the terminal device.

The account creation unit 104 may perform various sorts of settings of the account. Examples of the various sorts of settings include an account name, an icon of the account, an introduction sentence for the account, and whether to publish a post in a state that allows anyone to view the post or only to a predetermined account. For example, the account creation unit 104 may set the account name, the icon of the account, the introduction sentence for the account, and the like in such a way as to be information for expressing that the account is for the avatar of the user. For example, the account creation unit 104 may also set the account in such a way as to be published only to the account used by the user.

The account creation unit 104 may create an account in each of a plurality of types of SNSs, or may create an account in an SNS of which designation has been accepted from the user, among a plurality of types of SNSs.

In a case where a plurality of avatars is generated, the account creation unit 104 may create one account for each of the plurality of avatars, or may create one account shared by the plurality of avatars.

The collection unit 105 is an example of a collection means for collecting related information related to an interest or behavior of the user, based on the profile.

For example, the related information is information related to an interest or behavior of the user, such as a store or facility such as a retail store or a restaurant, an event, a work, an impression or reaction regarding the work, a uniform resource locator (URL) of a website in which those sorts of information are gathered, an image such as a still image or a moving image, information transmitted by a person, and the like.

For example, the collection unit 105 collects the related information related to an interest or behavior of the user indicated in the profile. The collection unit 105 may also collect related information related to other interest or behavior inferred based on the interest or behavior of the user indicated in the profile. A known technique may be used for the method for inferring other interest or behavior based on the interest or behavior of the user. Here, other interest or behavior is an interest or behavior different from the interest or behavior of the user and is, for example, an interest to which the user may be likely to newly pay attention or behavior that the user may be likely to execute.

The collection unit 105 may collect the related information, for example, by performing Internet search. For example, the collection unit 105 may also collect the related information on an SNS. In this case, the collection unit 105 may collect the related information from post content of other users or avatars of other users posted on an SNS.

For example, the collection unit 105 may collect the related information from a database prepared in advance. The database prepared in advance may be, for example, a database that stores information desired to be recommended by a company that runs information provision by the information provision device 100, but is not limited to this example.

For example, the collection unit 105 may perform a search using a keyword related to an interest or behavior of the user indicated in the profile or an inferred interest or behavior.

The collection unit 105 may also collect related information that has not been searched for or browsed by the user. For example, the collection unit 105 may collect related information newly posted in a time slot in which the user is not searching or browsing a website or the like. For example, the collection unit 105 may also collect, as the related information, information on a website or the like that has not been browsed by the user, among collected pieces of information, based on a browsing history of the user. The process of extracting the related information in this manner may be performed by the post generation unit 106.

The method by which the collection unit 105 collects the related information, the collection source, and the amount of the related information to be collected are not particularly limited.

The post generation unit 106 is an example of a post generation means for generating post content to an SNS, based on the related information.

The post content is, for example, at least one piece of the related information. In this case, the post generation unit 106 may select at least one piece of the related information and generate the selected piece of the related information as post content. The method for selecting at least one piece of the related information is not particularly limited, and related information having a high level of attraction based on the number of views or the number of reactions, latest related information, related information having a high degree of relevance in terms of the interest or behavior of the user, or the like may be selected from among pieces of the related information.

For example, the post content may include a message with respect to the related information in addition to the related information. The message with respect to the related information is, for example, a message intended to recommend the related information to the user. In this case, the post generation unit 106 may generate a message for recommending the related information to the user, using, for example, the LLM.

The message for recommending the related information to the user may be, for example, a message for conveying an impression on the related information. In this case, the post generation unit 106 may generate an impression in a case where the avatar browses the related information, a case where the avatar experiences an event indicated in the related information, or the like. For example, the post generation unit 106 may generate an impression, based on a reaction to the related information by another account on the SNS. For example, the post generation unit 106 may also generate an impression by inputting the related information into the LLM. The post generation unit 106 may generate an impression in such a way that the impression is positive.

When generating the message, the post generation unit 106 may generate the message in such a way as to have a way of speaking similar to the user. In this case, the post generation unit 106 may generate the message, using, for example, an LLM that has additionally learned a post history on an SNS of the user. For example, the post generation unit 106 may generate the message by inputting, into the LLM, a prompt including a part or the whole of the post history of the user on the SNS and an instruction to output a message in a way of speaking similar to the part or the whole of the post history.

When generating the message, the post generation unit 106 may generate a message in such a way as to have a way of speaking like that in an interaction with a friend. In this case, the post generation unit 106 may generate the message, for example, by inputting, into the LLM, a prompt including an instruction to output a message in a way of speaking like that in an interaction with a friend.

Since the message is in a way of speaking similar to the user or a way of speaking like that in an interaction with a friend, it can be considered that the user can easily feel a sense of closeness and a talk can be made easily understandable by the user.

The post generation unit 106 may generate post content, based on information that is not included in the behavior information, among pieces of the related information. In other words, the post generation unit 106 may generate post content, based on related information regarding a matter that the user has not experienced, among pieces of the related information. The related information that the user has not experienced is, for example, related information indicating a facility that the user has not visited, related information indicating a website that the user has not browsed, and related information indicating a work that the user has not viewed or listened to.

For example, a chat screen on the terminal device in FIG. 1 indicates post content by the avatar “A song called ΔΔ by ○○ is good!”. This post content includes a work of ΔΔ (here, a song name is assumed) by ○○ (here, an artist name is assumed), as the related information. This post content also includes a message of “good” that conveys an impression in a case of listening to the above work.

That is, for example, the post generation unit 106 may generate post content assuming that a work that the user has not viewed or listened to has been viewed or listened to, based on the behavior information on the user.

For example, the post generation unit 106 generates post content assuming that the avatar has performed behavior different from the behavior performed by the user in a predetermined position range from the current position of the user. This is, for example, in a case where the user is staying in a certain region, the post generation unit 106 generates post content intended to recommend information on a facility or an event in the same region but different from the facility that the user is currently visiting or the event that the user is participating in.

Since the post generation unit 106 generates the post content based on the related information that the user has not experienced, the user is highly likely to be able to obtain new information, and information provision is highly likely to be useful for the user.

The post generation unit 106 generates the post content in accordance with a format of a post on the SNS. For example, the post generation unit 106 generates the post content in such a way as to match a format such as a number of characters limit, an image size, and the number of images.

The information provision unit 107 is an example of an information provision means for providing information to the user by posting post content, using an account.

For example, the information provision unit 107 may provide information by inputting post content on an input screen for a new post and operating a post button in a logged-in state to the account.

For example, the information provision unit 107 may provide information as a chatbot on an SNS.

The method and the mode for providing information are not particularly limited.

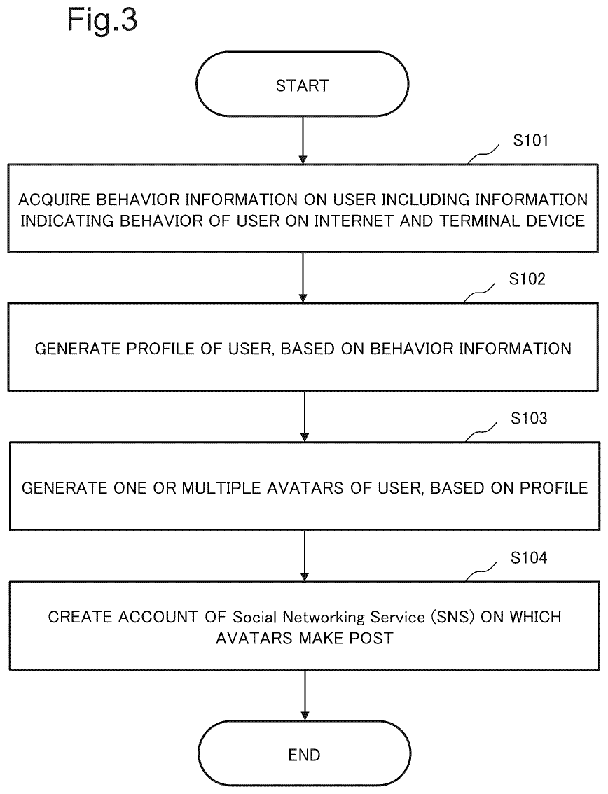

An example of an action of generating an avatar that provides information, among actions of the information provision device 100 configured as described above, will be described with reference to the flowchart in FIG. 3. It can also be said that the action of generating the avatar that provides information illustrated in FIG. 3 is a preparatory action for providing information to be described later.

First, the user information acquisition unit 101 acquires the behavior information on the user including information indicating behavior of the user on the Internet and the terminal device (step S101).

Next, the profile generation unit 102 generates a profile of the user, based on the behavior information acquired in step S101 (step S102).

Next, the avatar generation unit 103 generates one or multiple avatars of the user, based on the profile generated in step S102 (step S103).

Then, the account creation unit 104 creates an account of an SNS on which the avatars generated in step S103 make a post (step S104).

The information provision device 100 thus ends a series of actions for generating an avatar that provides information.

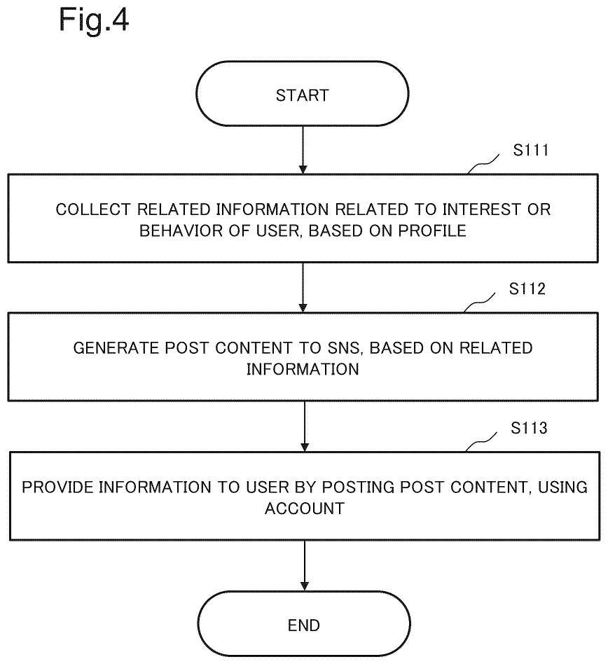

Next, an example of an action of providing information, among actions of the information provision device 100, will be described with reference to the flowchart in FIG. 4.

First, the collection unit 105 collects the related information related to an interest or behavior of the user, based on the profile of the user (step S111). The process in step S111 may be performed at predetermined time intervals or may be performed in response to a predetermined event. For example, the predetermined event may be occurrence of a change in interest or behavior of the user, predetermined behavior made by the user considered to be in a state of wanting to accept provided information, or the like.

Next, the post generation unit 106 generates post content to the SNS, based on the related information collected in step S111 (step S112).

Next, the information provision unit 107 provides information to the user by posting the post content generated in step S112, using the account (step S113). The process in step S113 may be performed at predetermined time intervals or may be performed in response to a predetermined event. For example, the predetermined event may be occurrence of a change in interest or behavior of the user, predetermined behavior made by the user considered to be in a state of wanting to accept provided information, or the like.

The information provision device 100 thus ends a series of actions for providing information.

The information provision device 100 according to the present example embodiment described above includes the user information acquisition unit 101, the profile generation unit 102, the avatar generation unit 103, the account creation unit 104, the collection unit 105, the post generation unit 106, and the information provision unit 107. The user information acquisition unit 101 acquires the behavior information on the user including information indicating behavior of the user on the Internet and the terminal device. The profile generation unit 102 generates a profile of the user, based on the behavior information on the user. The avatar generation unit 103 generates one or multiple avatars of the user, based on the profile of the user. The account creation unit 104 creates an account of an SNS on which the avatars make a post. The collection unit 105 collects the related information related to an interest or behavior of the user, based on the profile of the user. The post generation unit 106 generates post content to the SNS, based on the collected related information. The information provision unit 107 provides information to the user by posting the generated post content, using the account.

As a result, the information provision device 100 can provide an information providing technique designed to enable a user to collect information more comfortably.

For example, since the information provision device 100 provides information based on the profile of the user, information matching an interest or behavior of the user can be provided. For example, since the information provision device 100 provides information by posting on an SNS using the avatar of the user, information can be provided in a form more easily acceptable to the user than general advertisements.

Next, first to fifth modifications of the present disclosure will be described. Hereinafter, the description of content overlapping with the above description will be omitted to the extent that description of the first to fifth modifications is not unclear.

### First Modification

In a first modification, the information provision device 100 may have a conversation with the user, another user, or an avatar of another user.

In this case, for example, the post generation unit 106 further generates response content for responding to a reaction of the user to the post content or the post content of the avatar of another user. Then, the information provision unit 107 responds to the user or the avatar of another user by posting the response content, using the account.

For example, the post generation unit 106 may generate the response content by inputting the post content posted by the information provision unit 107 and a reaction to the posted post content into the model or the LLM. Here, the reaction is a reaction to the post content, such as an emoticon or a stamp, or post content that is a reply to the post content.

The response content may be at least one of a message indicating an impression or empathy to the reaction of the user and additional related information or a message recommending the additional related information.

As the additional related information, for example, in a case where the reaction of the user to the original post content is positive, the post generation unit 106 may generate the response content, based on related information having highly relevance to the original post content. For example, in a case where the reaction of the user to the original post content is negative, as the additional related information, the post generation unit 106 may generate the response content, for example, based on related information having low relevance to the original post content. The related information having low relevance to the original post content is, for example, different related information included in the same category as the original post content.

The post generation unit 106 may determine not to respond in a case where there is no additional topic in the reply to the post content.

The post generation unit 106 may generate response content for responding to the post content of the user other than the reply to the post content posted by the information provision unit 107. In this case, for example, the post generation unit 106 may generate the response content by inputting the post content of the user into the model or the LLM.

On the chat screen in the terminal device in FIG. 1, the user shows a reaction to the post of “A song called ΔΔ by ○○ is good!” posted by the information provision unit 107, with posts of “Really? I will listen to it.” and “It is so good! Favorite tone!”. In response to this reaction of the user, the information provision unit 107 posts response content such as “Yes! It is an exciting song” and “You may also like a song called ▭▭ in the same album”. The response content of “Yes! It is an exciting song” is an example of a message indicating an impression or empathy to the reaction of the user. The response content of “You may also like a song called ▭▭ in the same album” is an example of the additional related information and a message for recommending the additional related information.

Furthermore, in this case, the post generation unit 106 may determine not to respond to the post content of the user. In other words, the post generation unit 106 may generate response content for a part of the post content of the user, and the information provision unit 107 may post the response content.

For example, the post generation unit 106 may generate the response content to post content to which the user pays more attention, among pieces of the post content of the user. For example, the post generation unit 106 may generate the response content for the latest post among posts including a topic with a high post frequency in a predetermined period.

For example, the post generation unit 106 may also generate the response content to a post of the user at a predetermined frequency. Here, the predetermined frequency may be a frequency in terms of the number of posts or may be a temporal frequency.

In this manner, since the information provision device 100 has a conversation with the user, the user can deepen the understanding of and pay more attention to the content of provided information accepted by the user.

There is also a case where the information provision device 100 can collect new related information in a case where the information provision device 100 has a conversation with another user or an avatar of another user.

### Second Modification

Next, in a second modification, the information provision device 100 may update the profile of the user.

For example, the profile generation unit 102 updates the profile of the user, based on newly obtained behavior information. In a case where the profile is updated, the avatar generation unit 103 may update the avatar, based on the updated profile. The methods for updating the profile and the avatar are not particularly limited, and a known technique may be used.

The newly obtained behavior information may include, for example, a reaction of the user to post content posted by the information provision unit 107. That is, the profile generation unit 102 may update the profile, based on the reaction of the user to the post content.

For example, post content negatively reacted by the user is considered to be less interesting for the user. Therefore, the profile generation unit 102 may update the profile in such a way as to reduce the weight of the interest of the user for a category or an element of interest related to the negatively reacted post content. On the other hand, it is considered that the interest of the user is high in post content positively reacted by the user. Therefore, the profile generation unit 102 may update the profile in such a way as to raise the weight of the interest of the user for a category or an element of interest related to the positively reacted post content.

In this manner, by updating the profile of the user, the information provision device 100 can provide information according to a new interest or behavior of the user, and the user may sometimes be able to accept more useful provided information.

### Third Modification

Next, in a third modification, the information provision device 100 may provide not only the related information not experienced by the user but also information regarding a matter experienced by the user. In other words, the information provision device 100 may provide not only new related information for the user but also information for sharing an impression with the avatar undergoing the behavior of the user together.

In this case, for example, the post generation unit 106 generates post content assuming that the avatar has performed behavior performed by the user together with the user. For example, by causing the LLM to generate an impression assuming that the avatar has performed behavior performed by the user, based on the behavior information, the post generation unit 106 may generate post content for conveying the impression.

The post content for conveying an impression assuming that the avatar has performed behavior performed by the user may sometimes be useful information provision for the user because, for example, the post content helps the user to express the impression in language or serves as a record of memories for the user. With the post content for conveying an impression assuming that the avatar has performed behavior performed by the user, it may be likely that the user can feel a sense of closeness with the avatar and can easily accept other provided information.

### Fourth Modification

Next, in a fourth modification, the information provision device 100 may provide information regarding health of the user.

In this case, the user information acquisition unit 101 further acquires health information on the user, and the post generation unit 106 generates the post content further based on the health information on the user.

Here, the health information is information related to the health of the user, such as vital data, an amount of exercise such as the number of steps, a sleeping time, a medical examination result, and information indicating prescription medicine, for example.

In a case where the user has disorder or behavior that may be likely to cause disorder, the post generation unit 106 may generate post content including advice for improving the disorder or the behavior, based on the health information. When generating the advice, the post generation unit 106 may generate advice that is highly likely to be executed by the user, based on the profile of the user.

A known technique can be used for the method for specifying user's disorder or behavior that may be likely to cause disorder and the method for specifying advice for improving the specified disorder or behavior, based on the health information.

### Fifth Modification

Next, in a fifth modification, the information provision device 100 may perform posting as the user on the SNS.

The information provision unit 107 may perform posting, using an account of the user.

In this case, for example, the information provision unit 107 may make a post in such a way that it can be identified that the post is made by the avatar. For example, the information provision unit 107 posts post content to which information that makes the post content identifiable as a post by an avatar is appended.

For example, the information provision unit 107 may make a post in such a way that the user makes a post by himself/herself. That is, the information provision unit 107 may make a post without appending information that makes the post identifiable as a post by the avatar. In this case, for example, in a case where permission for posting is accepted from the user via a selection screen for selecting whether to permit posting in the account of the user, posting may be performed using the account of the user without indicating that the posting is by the avatar. Posting to the account of the user by the avatar may be permitted for each post or may be permitted for all posts in advance.

This may sometimes help the activity of the user using the SNS.

While the first to fifth modifications have been described above, the first to fifth modifications may be combined with each other.

### Hardware Configuration

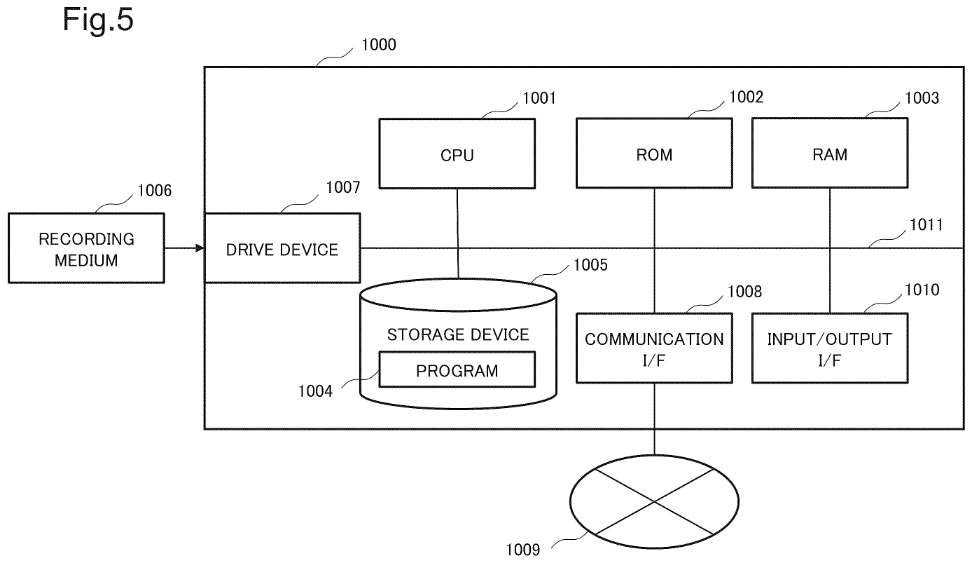

Some or all of the components of each device or system in each example embodiment and modification of the present disclosure described above are achieved by, for example, any combination of an information processing device 1000 and a program as illustrated in FIG. 5. As an example, the information processing device 1000 includes the constituent elements as follows.
Central processing unit (CPU) 1001
Read only memory (ROM) 1002
Random access memory (RAM) 1003
Program 1004 to be loaded into RAM 1003
Storage device 1005 storing program 1004
Drive device 1007 for reading and writing recording medium 1006
Communication I/F 1008 connected to communication network 1009
Input/output I/F 1010 for inputting and outputting data
Bus 1011 connecting each component

I/F is an abbreviation of the interface.

Each component of each device or system in each example embodiment and modification is achieved by the CPU 1001 acquiring and executing a program for achieving these functions. The program for achieving the function of each component of each device is stored in the storage device 1005 or the RAM 1003 in advance, for example, and is read by the CPU 1001, as necessary. The program 1004 may be supplied to the CPU 1001 via the communication network, or may be stored in advance in the recording medium 1006 in order for the drive device 1007 to read the stored program and supply the read program to the CPU 1001.

There are various modifications of the method for achieving each device. For example, each device or system may be achieved by any combination of the information processing device 1000 and the program different for each component. A plurality of components included in each device may be achieved by any combination of one information processing device 1000 and the program.

Some or all of the components of each device or system are achieved by a general-purpose or dedicated circuitry including a processor or the like, or a combination of the circuitries. The circuitry is, for example, a CPU, a graphics processing unit (GPU), a field programmable gate array (FPGA), or a large scale integration (LSI) for artificial intelligence (AI) processing. These units may be constituted by a single chip or may be constituted by a plurality of chips connected via a bus. Some or all of the components of each device may be achieved by a combination of the above-described circuitry or the like and the program.

In a case where some or all of the components of each device or system are achieved by a plurality of the information processing devices, circuitries, or the like, the plurality of information processing devices, circuitries, or the like may be arranged in a centralized manner or in a distributed manner. For example, the information processing devices, circuitries, or the like may be achieved in a form of a client-server system, a cloud computing system, or the like in which they are connected to each other via a communication network.

While the present disclosure has been particularly shown and described with reference to each example embodiment and modification thereof, the present disclosure is not limited to these example embodiments and modifications. It will be understood by those of ordinary skill in the art that various changes in form and details may be made therein without departing from the spirit and scope of the present disclosure as defined by the claims.

For example, the information provision device 100 may be achieved by devices existing separately from each other, such as an avatar generation device that generates an avatar and an avatar operation device that provides information using the avatar. In this case, the avatar generation device includes, for example, the user information acquisition unit 101, the profile generation unit 102, and the avatar generation unit 103. In this case, the avatar generation device may also include, for example, the account creation unit 104. In this case, the avatar operation device includes the collection unit 105, the post generation unit 106, and the information provision unit 107.

Although a plurality of actions is described in order in the form of a flowchart, this described order does not limit the order of executing the plurality of actions. Therefore, in a case where each example embodiment and modification is carried out, the order of the plurality of actions may be changed within a range that does not interfere with the content.

Some or all of the above-described example embodiments and modifications may be described as the following Supplementary Notes, but are not limited to the following.

### Supplementary Note 1

An information provision device including:
a user information acquisition means for acquiring behavior information on a user including information indicating behavior of the user on the Internet and a terminal device;
a profile generation means for generating a profile of the user, based on the behavior information;
an avatar generation means for generating one or multiple avatars of the user, based on the profile;
an account creation means for creating an account of a social networking service (SNS) on which the avatars make a post;
a collection means for collecting related information related to an interest or the behavior of the user, based on the profile;
a post generation means for generating post content to the SNS, based on the related information; and
an information provision means for providing information to the user by posting the post content, using the account.

### Supplementary Note 2

The information provision device according to Supplementary Note 1, in which

the post generation means further generates response content for responding to a reaction of the user to the post content or post content of an avatar of another user, and

the information provision means responds to the user or the avatar of another user by posting the response content, using the account.

### Supplementary Note 3

The information provision device according to Supplementary Note 1 or 2, in which

the profile generation means updates the profile, based on a reaction of the user to the post content.

### Supplementary Note 4

The information provision device according to any one of Supplementary Notes 1 to 3, in which

the post generation means generates the post content, based on information that is not included in the behavior information, among pieces of the related information.

### Supplementary Note 5

The information provision device according to Supplementary Note 4, in which

the post generation means generates the post content assuming that the avatars have performed behavior different from behavior performed by the user in a predetermined position range from a current position of the user.

### Supplementary Note 6

The information provision device according to any one of Supplementary Notes 1 to 5, in which

the post generation means generates the post content assuming that the avatars have performed behavior performed by the user together with the user.

### Supplementary Note 7

The information provision device according to any one of Supplementary Notes 1 to 6, in which

the user information acquisition means further acquires health information on the user, and

the post generation means generates the post content further based on the health information on the user.

### Supplementary Note 8

The information provision device according to any one of Supplementary Notes 1 to 7, in which

the collection means collects the related information from post content of an avatar of another user.

### Supplementary Note 9

An information provision method including:
acquiring behavior information on a user including information indicating behavior of the user on the Internet and a terminal device;
generating a profile of the user, based on the behavior information;
generating one or multiple avatars of the user, based on the profile;
creating an account of an SNS on which the avatars make a post;
collecting related information related to an interest or the behavior of the user, based on the profile;
generating post content to the SNS, based on the related information; and
providing information to the user by posting the post content, using the account.

### Supplementary Note 10

A program for causing a computer to execute a process including:
acquiring behavior information on a user including information indicating behavior of the user on the Internet and a terminal device;
generating a profile of the user, based on the behavior information;
generating one or multiple avatars of the user, based on the profile;
creating an account of an SNS on which the avatars make a post;
collecting related information related to an interest or the behavior of the user, based on the profile;
generating post content to the SNS, based on the related information; and
providing information to the user by posting the post content, using the account.

Some or all of the configurations described in Supplementary Notes 2 to 8 dependent on Supplementary Note 1 (information provision device) described above can also be dependent on Supplementary Note 9 (information provision method) and Supplementary Note 10 (program) by the same dependency relationship as Supplementary Notes 2 to 8. Some or all of the configurations described as the Supplementary Notes can be similarly dependent on not only the Supplementary Notes 1, 9, and 10, but also various pieces of hardware and software, various types of recording means for recording software, or systems without departing from the above-described example embodiments and modifications.

There is a technique for providing information for recommending a product, a service, a facility, an event, or the like in such a way as to match a preference or an interest of a user.

Meanwhile, recently, the number of times the recommendation information is provided increases, and the user may sometimes feel annoyed.

An example of an effect of the present disclosure is that an information providing technique designed to enable a user to collect information more comfortably can be provided.

1. An information provision device comprising:
one or more memories storing instructions; and
one or more processors configured to execute the instructions to:
acquire behavior information on a user including information indicating behavior of the user on the Internet and a terminal device;
generate a profile of the user, based on the behavior information;
generate one or multiple avatars of the user, based on the profile;
create an account of a social networking service (SNS) on which the avatars make a post;
collect related information related to an interest or the behavior of the user, based on the profile;
generate post content to the SNS, based on the related information; and
provide information to the user by posting the post content, using the account.

2. The information provision device according to claim 1, wherein the one or more processors are configured to execute the instructions to:
further generate response content for responding to a reaction of the user to the post content or post content of an avatar of another user, and
respond to the user or the avatar of another user by posting the response content, using the account.

3. The information provision device according to claim 1, wherein the one or more processors are configured to execute the instructions to:
update the profile, based on a reaction of the user to the post content.

4. The information provision device according to claim 1, wherein the one or more processors are configured to execute the instructions to:
generate the post content, based on information that is not included in the behavior information, among pieces of the related information.

5. The information provision device according to claim 4, wherein the one or more processors are configured to execute the instructions to:
generate the post content assuming that the avatars have performed behavior different from behavior performed by the user in a predetermined position range from a current position of the user.

6. The information provision device according to claim 1, wherein the one or more processors are configured to execute the instructions to:
generate the post content assuming that the avatars have performed behavior performed by the user together with the user.

7. The information provision device according to claim 1, wherein the one or more processors are configured to execute the instructions to:
further acquire health information on the user, and
generate the post content further based on the health information on the user.

8. The information provision device according to claim 1, wherein the one or more processors are configured to execute the instructions to:
collect the related information from post content of an avatar of another user.

9. An information provision method comprising:
acquiring behavior information on a user including information indicating behavior of the user on the Internet and a terminal device;
generating a profile of the user, based on the behavior information;
generating one or multiple avatars of the user, based on the profile;
creating an account of an SNS on which the avatars make a post;
collecting related information related to an interest or the behavior of the user, based on the profile;
generating post content to the SNS, based on the related information; and
providing information to the user by posting the post content, using the account.

10. A non-transitory recording medium that records a program for causing a computer to execute a process comprising:
acquiring behavior information on a user including information indicating behavior of the user on the Internet and a terminal device;
generating a profile of the user, based on the behavior information;
generating one or multiple avatars of the user, based on the profile;
creating an account of an SNS on which the avatars make a post;
collecting related information related to an interest or the behavior of the user, based on the profile;
generating post content to the SNS, based on the related information; and
providing information to the user by posting the post content, using the account.
